(19) United States
(12) Patent Application Publication
(10) Pub. No.: US 2023/0331918 A1
(43) Pub. Date: Oct. 19, 2023

(54) AMMONIUM AND SULFONIUM SULFONATE ZWITTERIONS AND POLYMERS DERIVED THEREFROM

(71) Applicant: University of Massachusetts, Boston, MA (US)

(72) Inventors: Marcel U. Brown, Amherst, MA (US); Todd Emrick, South Deerfield, MA (US)

(21) Appl. No.: 18/131,042

(22) Filed: Apr. 5, 2023

Related U.S. Application Data
(60) Provisional application No. 63/330,362, filed on Apr. 13, 2022.

(51) Int. Cl. C08G 75/30

(52) U.S. Cl. CPC C08G 75/30

(57) ABSTRACT

A zwitterion has a structure according to the Formula

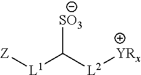

wherein Z, L¹, L², R, Y, and x are as defined herein. The zwitterions can be used to provide the corresponding polymer zwitterions, for example using free radical polymerization techniques.

### CROSS REFERENCE TO RELATED APPLICATION

This application claims the benefit of and priority to U.S. Provisional Application No. 63/330,362, filed Apr. 13, 2022, the content of which is incorporated by reference herein in its entirety.

### FEDERAL RESEARCH STATEMENT

This invention was made with government support under award number 1904660 awarded by the National Science Foundation. The government has certain rights in the invention.

### BACKGROUND

The emergence of polymer zwitterions (PZs) as an increasingly prominent topic in polymeric and soft materials science motivates the discovery of new chemical compositions and fundamental structure-property relationships, with examination of applications that cannot be achieved with conventional PZ structures. Traditionally, PZs are most notable for their properties as antifouling coatings, a characteristic that is commonly attributed to their extreme hydrophilicity. Generally, the properties of PZs can be tuned by variation of the chemical composition associated with the anion or cation, the dipole orientation, the backbone structure, and the substituents emanating from the ionic centers. The range of accessible structures has been limited primarily to nitrogen-based cations, with a recent report of 4-vinylbenzyl sultone as a monomer precursor enabling the preparation of novel zwitterionic monomers and polymers containing phosphonium cations.

There remains a continuing need for new PZ structures to provide materials with tunable properties, including solubility, interfacial activity, and solution configuration.

### SUMMARY

An aspect of the present disclosure is a zwitterion of the Formula

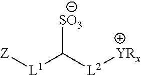

wherein Z is a polymerizable group comprising ethylenic unsaturation; L¹ is a single bond or divalent C₁₋₆ alkylene group; L² is a divalent ethylene or propylene group; Y is N or S; R is independently at each occurrence a substituted or unsubstituted C₁₋₁₈ alkyl group or a substituted or unsubstituted C₆₋₂₀ aryl group, and x is 2 or 3, provided that when Y is S, x is 2; and when Y is N and x is 2, the R groups are joined together to form a substituted or unsubstituted aromatic ring.

Another aspect is a polymer comprising repeating units derived from the zwitterion.

A method of making the polymer comprises contacting the zwitterion and an initiator under conditions effective to provide the polymer.

The above described and other features are exemplified by the following figures and detailed description.

### BRIEF DESCRIPTION OF THE DRAWINGS

The following figures represent exemplary embodiments.

FIG. 1 is a chemical scheme showing ring-opening reactions for the preparation of ammonium sulfonate-substituted zwitterionic monomers (tertiary amines—top; pyridine—bottom) and their conversion to the corresponding polymers by RAFT polymerization.

FIG. 2 is a chemical scheme showing ring-opening reactions for the preparation of a sulfonium sulfonate-substituted zwitterionic monomer and conversion to the corresponding polymer by RAFT polymerization.

FIG. 3 shows representative gel permeation chromatography (GPC) traces of SAS PZs at varying molecular weights for (a) the trimethyl ammonium derivative and (b) the pyridinium derivative.

FIG. 4 shows a plot of the hydrodynamic radii, and corresponding schematic illustrations, for the fast and slow modes of polymers obtained from dynamic light scattering (DLS).

FIG. 5 shows pendant drop tensiometry data for TCB-in-water droplets using SAS and SPS PZs. (a) Plot of interfacial tension vs. time comparing all SAS derivatives and the tri-n-butyl phosphonium derivative with a needle diameter of 1.57 mm and ˜6 μL droplet volume; (b) Plot of interfacial tension vs time, comparing the n-butyl pSAS and n-butyl pSPS with a smaller needle of 0.82 mm and droplet size of ˜2 μL. (c) Equilibrium interfacial tension values for SAS derivatives and the n-butyl-substituted SPS.

FIG. 6 shows optical microscopy of w/o/w emulsions stabilized by n-butyl pSAS (left); confocal fluorescence microscopy of w/o/w emulsions stabilized by n-butyl pSAS (center); and confocal fluorescence microscopy of w/o/w emulsions stabilized by n-butyl SPS polymer (right).

### DETAILED DESCRIPTION

The present inventors have discovered that a particular sultone precursor proved amenable to ring-opening with nucleophiles other than phosphines, such as tertiary amines or dialkyl or diaryl sulfides, affording a new set of zwitterionic ammonium sulfonate and sulfonium sulfonate monomers and polymers. Ammonium-based PZs, such as the sulfobetaine (SB) and phosphorylcholine (PC)-substituted methacrylates are among the most popular PZs, with more recent reports varying the substituents on the cation, including aliphatic and cyclic examples. However, the present inventors recognized that a one-step synthesis of variously substituted ammonium sulfonate PZs from a common cyclic precursor and commercially available amines, would be advantageous relative to more complex synthetic strategies. Thus, preparing a new set of PZs with identical architectures, differing only by the substituents at the cationic center, allows for investigation of fundamental structure-property relationships that are valuable for evaluating PZ design criteria. Moreover, the PZ structures described here give access to direct comparisons with the styrenic phosphonium sulfonate (SPS) zwitterions, and specifically the impact of nitrogen or sulfur versus phosphorous as the cationic center.

Accordingly, the present disclosure describes the synthesis of a new library of ammonium sulfonate and sulfonium sulfonate PZs and characterization of their fundamental solution and fluid interface properties.

An aspect of the present disclosure is a zwitterion comprising a positively charged nitrogen-containing group or a positively charged sulfur-containing group and a negatively charged sulfonate group on the same compound. Thus, the zwitterion is net-neutral. The zwitterion advantageously comprises a polymerizable group comprising ethylenic unsaturation, which can provide a functional handle for further chemistry (e.g., polymerization). Specifically, the zwitterion is of the Formula

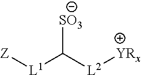

wherein Z is a polymerizable group comprising ethylenic unsaturation; L¹ is a single bond or divalent C₁₋₆ alkylene group; L² is a divalent ethylene or propylene group; Y is nitrogen (N) or sulfur (S); R is independently at each occurrence a substituted or unsubstituted C₁₋₁₈ alkyl group or a substituted or unsubstituted C₆₋₂₀ aryl group, and x is 2 or 3, provided that when Y is S, x is 2; and when Y is N and x is 2, the R groups are joined together to form a substituted or unsubstituted aromatic ring.

The Z group can preferably be a styrenic derivative or a (meth)acrylic derivative, specifically a group of the Formula

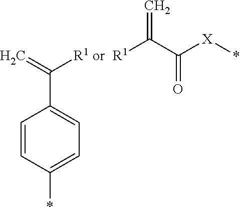

wherein R¹ is H or a methyl group, and X is —O— or —NH—. The “*” indicates the point of attachment of the polymerizable Z group to the rest of the compound, e.g., to the L¹ group. In an aspect, R¹ can be H. In an aspect, X can be —O—.

In an aspect, L¹ of the zwitterion can be a divalent C₁₋₆ alkylene group, for example a divalent methylene group. In an aspect, L¹ of the zwitterion can be a single bond (i.e., wherein Z is directly connected to the carbon bearing the sulfonate group). In an aspect, L² of the zwitterion can be a divalent ethylene group. In a specific aspect, Z can be a group of the Formula

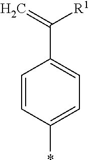

wherein R¹ is H, L¹ is a divalent methylene group, and L² is a divalent ethylene group.

In an aspect, the zwitterion can be an ammonium sulfonate zwitterion (i.e., wherein Y is nitrogen (N)). The ammonium sulfonate zwitterion can be of the Formula

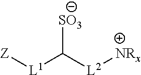

wherein Z, L¹, L², R, and x are as described above. In an aspect x is 3 and each occurrence of R is a substituted or unsubstituted C₁₋₁₂ alkyl group. In an aspect, x is 2 and the R groups are joined together to form a substituted or unsubstituted aromatic ring, preferably a pyridine ring.

In an aspect, the ammonium sulfonate zwitterion can be of the Formula

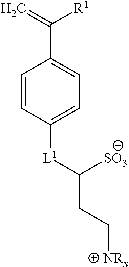

wherein R¹ is H or a methyl group; L¹ is a single bond or a divalent C₁₋₆ alkylene group; L² is a divalent ethylene or propylene group; R is independently at each occurrence a substituted or unsubstituted C₁₋₁₈ alkyl group; and x is 2 or 3, provided that when x is 2, the R groups are joined together to form a substituted or unsubstituted aromatic ring, preferably to form a substituted or unsubstituted pyridinium ring. In an aspect, R¹ can be H, L¹ can be a divalent methylene group, and L² can be a divalent ethylene group. In an aspect, each R group is the same. In an aspect, the R groups may be different.

In a specific aspect, Y is N, R¹ is H, L¹ is a divalent methylene group, L² is a divalent ethylene group, x is 3, and each occurrence of R is methyl. For example, the ammonium sulfonate zwitterion can be of the Formula

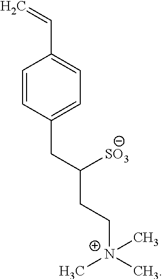

In another specific aspect, Y is N, R¹ is H, L¹ is a divalent methylene group, L² is a divalent ethylene group, x is 3, and each occurrence of R is ethyl. For example, the ammonium sulfonate zwitterion can be of the Formula

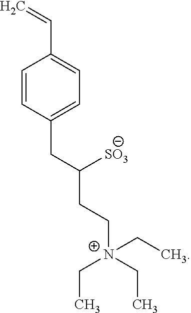

In another specific aspect, Y is N, R¹ is H, L¹ is a divalent methylene group, L² is a divalent ethylene group, x is 3, and each occurrence of R is n-propyl. For example, the ammonium sulfonate zwitterion can be of the Formula

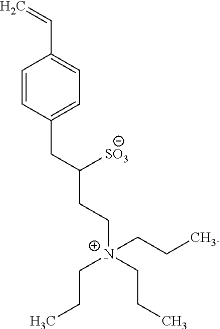

In yet another specific aspect, Y is N, R¹ is H, L¹ is a divalent methylene group, L² is a divalent ethylene group, x is 3, and each occurrence of R is n-butyl. For example, the ammonium sulfonate zwitterion can be of the Formula

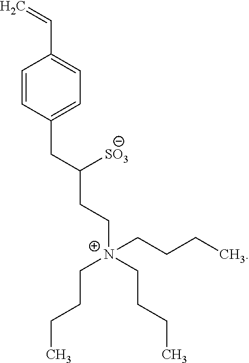

In still another specific aspect, Y is N, R¹ is H, L¹ is a divalent methylene group, L² is a divalent ethylene group, x is 3, and each occurrence of R is n-octyl. For example, the ammonium sulfonate zwitterion can be of the Formula

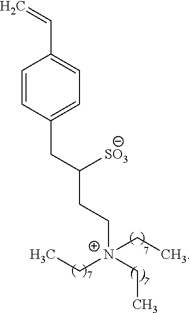

In an aspect, Y is N, x is 2, and the R groups can be joined together to form a substituted or unsubstituted pyridinium ring. For example, the ammonium sulfonate zwitterion can be of the Formula

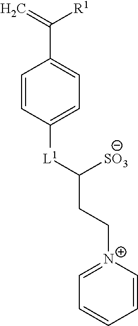

wherein R¹, L¹, and L² can be as defined above. In a specific aspect, R¹ is H, L¹ is a divalent methylene group, and L² is a divalent ethylene group. For example, the ammonium sulfonate zwitterion can be of the Formula

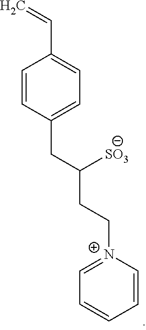

In another aspect, Z of the ammonium sulfonate zwitterion (i.e., wherein Y is N) can be a group of the Formula

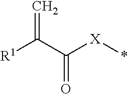

wherein R¹ is H or a methyl group, and X is —O— or —NH—. The “*” indicates the point of attachment of the polymerizable Z group to the rest of the compound, e.g., to the L¹ group. In an aspect, R¹ can be H. In an aspect, R¹ can be methyl. In an aspect, X can be —O—.

In an aspect, the zwitterion can be of the Formula

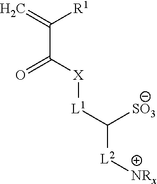

wherein R¹ is H or a methyl group; L¹ is a single bond or a divalent C₁₋₆ alkylene group; L² is a divalent ethylene or propylene group; R is independently at each occurrence a substituted or unsubstituted C₁₋₁₈ alkyl group; and x is 2 or 3, provided that when x is 2, the R groups are joined together to form a substituted or unsubstituted aromatic ring, preferably to form a substituted or unsubstituted pyridinium ring. In an aspect, L¹ can be a divalent methylene group, and L² can be a divalent ethylene group.

In a specific aspect, L¹ is a divalent methylene group, L² is a divalent ethylene group, x is 3, and each occurrence of R is methyl. For example, the ammonium sulfonate zwitterion can be of the Formula

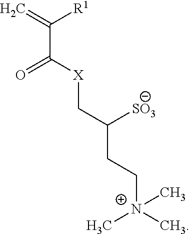

In another specific aspect, L¹ is a divalent methylene group, L² is a divalent ethylene group, x is 3, and each occurrence of R is ethyl. For example, the ammonium sulfonate zwitterion can be of the Formula

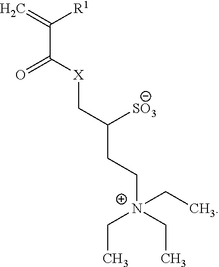

In another specific aspect, L¹ is a divalent methylene group, L² is a divalent ethylene group, x is 3, and each occurrence of R is n-propyl. For example, the ammonium sulfonate zwitterion can be of the Formula

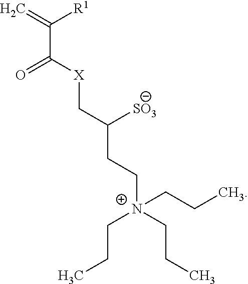

In yet another specific aspect, L¹ is a divalent methylene group, L² is a divalent ethylene group, x is 3, and each occurrence of R is n-butyl. For example, the ammonium sulfonate zwitterion can be of the Formula

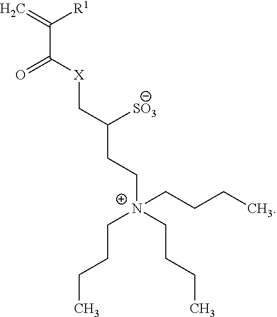

In still another specific aspect, L¹ is a divalent methylene group, L² is a divalent ethylene group, x is 3, and each occurrence of R is n-octyl. For example, the ammonium sulfonate zwitterion can be of the Formula

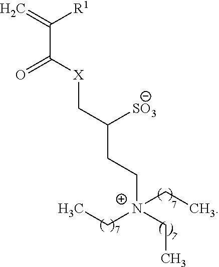

In an aspect when Y is N, x can be 2 and the R groups can be joined together to form a substituted or unsubstituted pyridinium ring. For example, the ammonium sulfonate zwitterion can be of the Formula

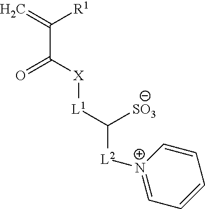

wherein R¹, X, L¹, and L² can be as defined above. In a specific aspect, L¹ is a divalent methylene group, and L² is a divalent ethylene group. For example, the ammonium sulfonate zwitterion can be of the Formula

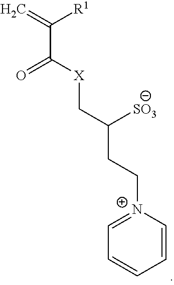

In an aspect, the zwitterion can be a sulfonium sulfonate zwitterion (i.e., wherein Y is sulfur (S)). Accordingly, the sulfonium sulfonate zwitterion can be of the Formula

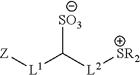

wherein Z, L¹, L², and R are as defined previously. Each occurrence of R can be the same or different. In an aspect, each occurrence of R is different.

In a specific aspect, Z can be a styrenic group and the sulfonium sulfonate zwitterion can be of the Formula

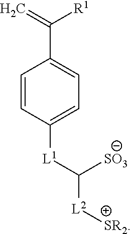

In an aspect, Y is S, R¹ is H, L¹ is a divalent methylene group, L² is a divalent ethylene group, and each occurrence of R is a C₁₋₆ alkyl group, wherein the R groups are different from one another. For example, the sulfonium sulfonate zwitterion can comprise a methyl group and a butyl group. For example, the sulfonium sulfonate zwitterion can be of the Formula

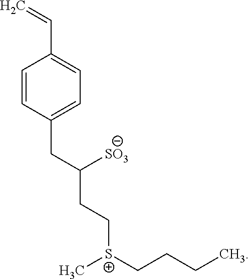

In an aspect, Z of the sulfonium sulfonate zwitterion (i.e., wherein Y is S) can be a group of the Formula

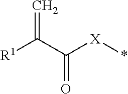

wherein R¹ is H or a methyl group, and X is —O— or —NH—. The “*” indicates the point of attachment of the polymerizable Z group to the rest of the compound, e.g., to the L¹ group. In an aspect, R¹ can be H. In an aspect, R¹ can be methyl. In an aspect, X can be —O—.

Accordingly, in an aspect, the sulfonium sulfonate zwitterion can be of the Formula

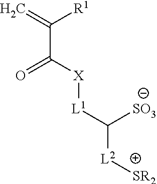

wherein R¹, L¹, L², and X can be as defined previously.

The ammonium sulfonate and sulfonium sulfonate zwitterions of the present disclosure include a polymerizable group. Accordingly, polymers derived from the ammonium sulfonate and sulfonium sulfonate zwitterions represent another aspect of the present disclosure. The polymer comprises repeating units derived from the ammonium sulfonate or sulfonium sulfonate zwitterion. The polymer can be a homopolymer, consisting of repeating units derived from the ammonium sulfonate or sulfonium sulfonate zwitterion. Alternatively, the polymer can be a copolymer comprising repeating units derived from more than one ammonium sulfonate zwitterion, more than one sulfonium sulfonate, repeating units derived from the ammonium sulfonate zwitterion and repeating units not derived from the ammonium sulfonate zwitterion, repeating units derived from the sulfonium sulfonate zwitterion and repeating units not derived from the sulfonium sulfonate zwitterion, or any combination thereof. Repeating units not derived from the ammonium sulfonate or sulfonium sulfonate zwitterion can include, for example, other zwitterions, non-zwitterionic monomers, or a combination thereof. When present as a copolymer, the copolymer can be a block copolymer, a random copolymer, or a graft copolymer. The polymer of the present disclosure is not limited to a particular architecture and can be, for example, linear, branched, hyperbranched, star, comb, bottle brush, and the like or a combination thereof. In an aspect, the polymer is a linear polymer (e.g., having a linear backbone formed from the polymerizable group of the ammonium sulfonate or sulfonium sulfonate zwitterion). In an aspect, the polymer is a linear homopolymer consisting of repeating units derived from the ammonium sulfonate or sulfonium sulfonate zwitterion.

The polymer of the present disclosure comprises repeating units of the Formula

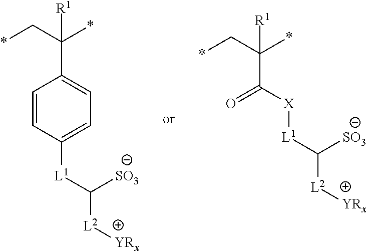

wherein R¹ is H or a methyl group; X is —O— or —NH—; L¹ is a single bond or a divalent C₁₋₆ alkylene group; L² is a divalent ethylene or propylene group; Y is N or S; R is independently at each occurrence a substituted or unsubstituted C₁₋₁₈ alkyl group or a substituted or unsubstituted C₆₋₂₀ aryl group; and x is 2 or 3, provided that when Y is S, x is 2; and when Y is N and x is 2, the R groups are joined together to form a substituted or unsubstituted aromatic ring. In an aspect, L¹ a methylene group and L² is an ethylene group.

In an aspect, the polymer comprises repeating units derived from the ammonium sulfonate, and said repeating units are of the formula

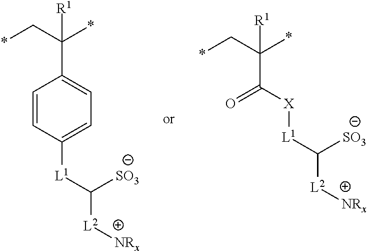

wherein R¹ is H or a methyl group; X is —O— or —NH—; L¹ is a single bond or a divalent C₁₋₆ alkylene group; L² is a divalent ethylene or propylene group; R is independently at each occurrence a substituted or unsubstituted C₁₋₁₈ alkyl group or a substituted or unsubstituted C₆₋₂₀ aryl group; and x is 2 or 3, provided that when x is 2, the R groups are joined together to form a substituted or unsubstituted aromatic ring.

In an aspect, the polymer comprises repeating units of the Formula

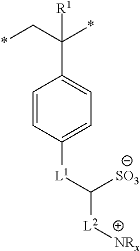

wherein R¹, L¹, L², and x are as defined above. In an aspect, R¹ is H, L¹ a methylene group and L² is an ethylene group.

In a specific aspect, R¹ is H, L¹ is a divalent methylene group, L² is a divalent ethylene group, x is 3, and each occurrence of R is methyl. For example, the polymer can comprise repeating units of the Formula

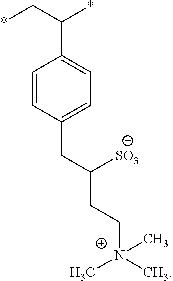

In another specific aspect, R¹ is H, L¹ is a divalent methylene group, L² is a divalent ethylene group, x is 3, and each occurrence of R is ethyl. For example, the polymer can comprise repeating units of the Formula

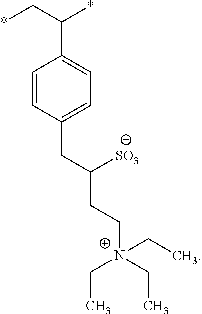

In another specific aspect, R¹ is H, L¹ is a divalent methylene group, L² is a divalent ethylene group, x is 3, and each occurrence of R is n-propyl. For example, the polymer can comprise repeating units of the Formula

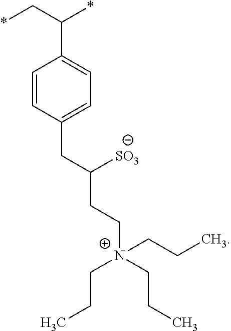

In yet another specific aspect, R¹ is H, L¹ is a divalent methylene group, L² is a divalent ethylene group, x is 3, and each occurrence of R is n-butyl. For example, the polymer can comprise repeating units of the Formula

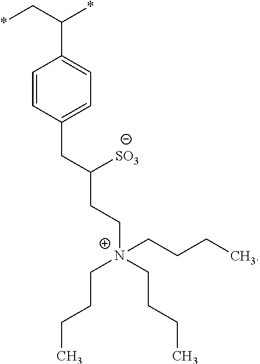

In still another specific aspect, R¹ is H, L¹ is a divalent methylene group, L² is a divalent ethylene group, x is 3, and each occurrence of R is n-octyl. For example, polymer can comprise repeating units of the Formula

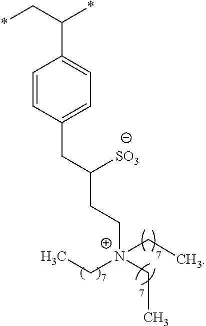

In an aspect, x can be 2 and the R groups can be joined together to form a substituted or unsubstituted pyridinium ring. For example, the polymer can comprise repeating units of the Formula

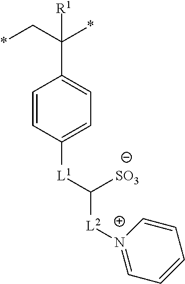

wherein R¹, L¹, and L² can be as defined above. In a specific aspect, R¹ is H, L¹ is a divalent methylene group, and L² is a divalent ethylene group. For example, the ammonium sulfonate zwitterion can be of the Formula

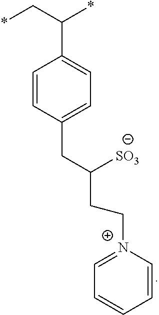

In an aspect, the polymer comprises repeating units of the Formula

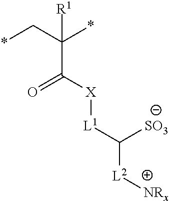

wherein R¹, L¹, L², and x are as defined above. In an aspect, L¹ a methylene group and L² is an ethylene group.

In a specific aspect, L¹ is a divalent methylene group, L² is a divalent ethylene group, x is 3, and each occurrence of R is methyl. For example, the polymer can comprise repeating units of the Formula

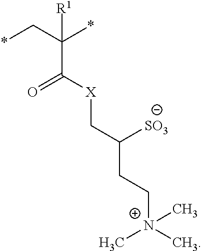

In another specific aspect, L¹ is a divalent methylene group, L² is a divalent ethylene group, x is 3, and each occurrence of R is ethyl. For example, the polymer can comprise repeating units of the Formula

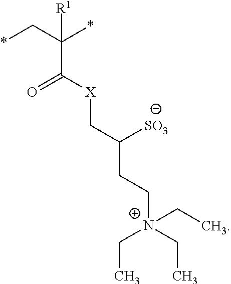

In another specific aspect, L¹ is a divalent methylene group, L² is a divalent ethylene group, x is 3, and each occurrence of R is n-propyl. For example, the polymer can comprise repeating units of the Formula

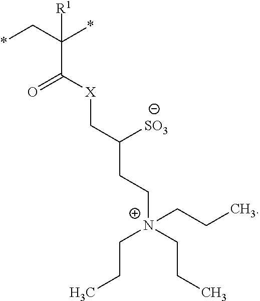

In yet another specific aspect, L¹ is a divalent methylene group, L² is a divalent ethylene group, x is 3, and each occurrence of R is n-butyl. For example, the polymer can comprise repeating units of the Formula

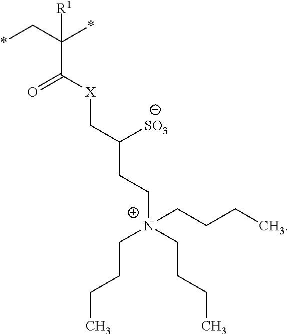

In still another specific aspect, L¹ is a divalent methylene group, L² is a divalent ethylene group, x is 3, and each occurrence of R is n-octyl. For example, polymer can comprise repeating units of the Formula

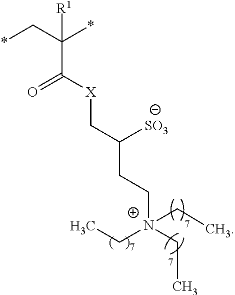

In an aspect, x can be 2 and the R groups can be joined together to form a substituted or unsubstituted pyridinium ring. For example, the polymer can comprise repeating units of the Formula

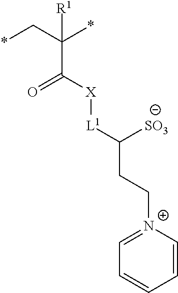

wherein R¹, L¹, and L² can be as defined above. In a specific aspect, L¹ is a divalent methylene group, and L² is a divalent ethylene group. For example, the ammonium sulfonate zwitterion can be of the Formula

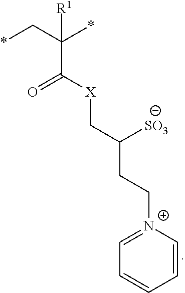

In an aspect, the polymer of the present disclosure comprises repeating units derived from the sulfonium sulfonate, and said repeating units are of the Formula

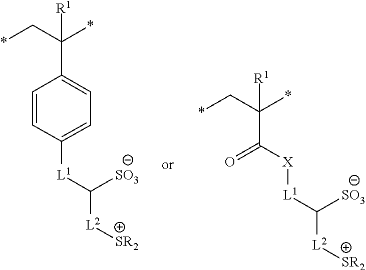

wherein R¹ is H or a methyl group; X is —O— or —NH—; L¹ is a single bond or a divalent C₁₋₆ alkylene group; L² is a divalent ethylene or propylene group; Y is N or S; R is independently at each occurrence a substituted or unsubstituted C₁₋₁₈ alkyl group or a substituted or unsubstituted C₆₋₂₀ aryl group. For example, in a specific aspect, the polymer can comprise repeating units of the Formula

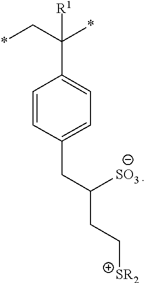

In an aspect, each occurrence of R is a C₁₋₆ alkyl group and is different. For example, in an aspect, R comprises a methyl group and a butyl group.

Polymers comprising combinations of any of the foregoing ammonium sulfonate or sulfonium sulfonate zwitterions are contemplated by the present disclosure. The polymers described herein can optionally be crosslinked. In an aspect, the polymers are uncrosslinked (e.g., wherein less than 5 mole percent of the repeating units of the polymer are crosslinked, or less than 1 mole percent of the repeating units of the polymer are crosslinked, preferably wherein no crosslinking is detected).

In an aspect, the polymer can be soluble in water. For example, the polymer can have the structure

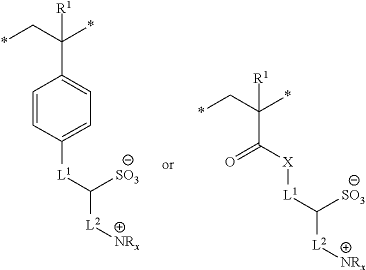

wherein x is 3, and each R group is independently a C₁₋₆ alkyl group, preferably a C₁₋₄ alkyl group or wherein x is 2 and the R groups are joined together to form a pyridinium group, and the polymer is soluble in water. For example, the polymer can be dissolved water at a concentration of at least 5 milligrams per milliliter, or at least 10 milligrams per milliliter

In an aspect, the polymer is soluble in a polar organic solvent, for example methanol, dimethylsulfoxide, trifluoroethanol (TFE), and the like. For example, the polymer can be dissolved in the polar organic solvent at a concentration of at least 5 milligrams per milliliter, or at least 10 milligrams per milliliter.

The polymer can have a number average molecular weight of 1,000 to 100,000 grams per mole. Within this range, the number average molecular weight can be, for example, 5,000 to 50,000 grams per mole, more preferably 5,000 to 30,000 grams per mole, or 5,000 to 25,000 grams per mole, or 10,000 to 30,000 grams per mole. In an aspect, the polymer can have a narrow dispersity index, for example less than 2, or 1.01 to less than 2, or 1.01 to 1.5, or 1.01 to 1.3, or 1.01 to 1.2, or 1.01 to 1.1. Molecular weight and dispersity can be determined, for example, using gel permeation chromatography (GPC) in 2,2,2-trifluoroethanol relative to poly(methyl methacrylate) standards.

A method of the making the polymers represents another aspect of the present disclosure. The ammonium sulfonate or sulfonium sulfonate zwitterions comprise a polymerizable group which can be polymerized, for example using radical polymerization techniques. Accordingly, a method of making the polymers of the present disclosure can comprise contacting the ammonium sulfonate or sulfonium sulfonate zwitterion monomer with an initiator. The initiator can be a conventional free radical initiator. The contacting can be in the presence of a solvent. Suitable solvents can include, for example, water, methanol, dimethyl sulfoxide, trifluoroethanol, and combinations comprising at least one of the foregoing The contacting is under conditions effective to provide the desired polymer. For example, conditions effective to provide the polymer can include a temperature of 50 to 100° C. and for a time of 1 to 24 hours, or 1 to 20 hours, or 5 to 20 hours.

In an aspect, a controlled free radical polymerization process can be used, for example reversible addition-fragmentation transfer (RAFT) polymerization. Accordingly, in an aspect, the method can comprise contacting the ammonium sulfonate or sulfonium sulfonate zwitterion, a free radical initiator, and a chain transfer agent in the present of a solvent under conditions effective to provide the polymer. The conditions effective to provide the polymer can include a temperature of 50 to 100° C. and for a time of 1 to 24 hours, or 1 to 20 hours, or 5 to 20 hours. Exemplary methods of making the polymers are further described in the working examples below.

This disclosure is further illustrated by the following examples, which are non-limiting.

### Examples

### Synthesis of Zwitterionic Ammonium Sulfonate Monomers

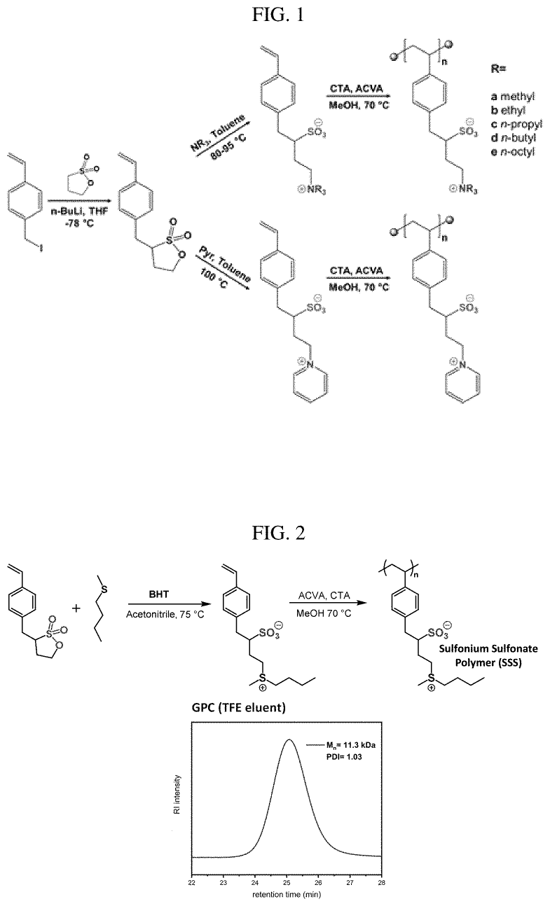

All of the zwitterionic monomers in FIG. 1 and FIG. 2 were prepared utilizing 4-vinylbenzyl sultone as the cyclic precursor. Several nucleophilic amines, specifically pyridine and the tertiary amines trimethyl, triethyl, tri-n-propyl, tri-n-butyl, and tri-n-octylamine, were used in the ring-opening of 4-vinylbenzyl sultone by stirring as toluene solutions at 80-100° C. During the course of the reaction, ammonium sulfonate monomers precipitated from toluene as colorless solids. FIG. 1 depicts a chemical scheme of the synthesis of representative ammonium sulfonate monomers and polymers, and FIG. 2 depicts a chemical scheme of the synthesis of representative sulfonium sulfonate monomers and polymers. These monomer syntheses were conducted on a multigram scale to give yields in the 85-99% range. Monomer solubility (e.g., in water, methanol, or chloroform) varied with the selection of R-groups on the ammonium cation. For example, the tri-n-propyl derivative formed a clear solution in MeOH at room temperature at high concentrations (˜500 mg mL-1), while the tri-n-butyl derivative required slightly elevated temperatures to attain solubility in MeOH at a similar concentration. Successful monomer preparations were confirmed by ¹H and ¹³C-nuclear magnetic resonance (NMR) spectroscopic characterization, as well as electrospray ionization (ESI) mass spectrometry. In the ¹HNMR spectra, signals characteristic of the styrenic protons appear between 7.1 and 7.5 ppm, while additional aromatic signals are found between 8.0 and 8.8 ppm for the pyridinium derivative. The three vinyl protons generate one resonance each, at 5.2, 5.8, and 6.7 ppm, while the alkyl signals of the ring-opened sultone, as well as those of the substituents on the cationic moieties of the alkyl ammonium monomers, appear between 0.9 and 3.7 ppm.

These ammonium sulfonate zwitterions may be viewed as “inverted sulfobetaines,” as the ions and the direction of the dipole associated with the inner salt structure is inverted relative to the SB-substituted methacrylate and styrenic polymers typically encountered in the literature. See, e.g., M. Mertoglu, S. Gamier, A. Laschewsky, K. Skrabania, J. Storsberg. Polymer 2005, 46, 7726-7740; P. Köberle and A. Laschewsky. Macromolecules 1994, 27, 2165-2173; V. Hildebrand, A. Laschewsky, M. Pach, P. Müller-Buschbaum, C. M. Papadakis. Polym. Chem. 2017, 8, 310-322; N. Wang, B. T. Seymour, E. M. Lewoczko, E. W. Kent, M. Chen, J. Wang, B. Zhao. Polym. Chem. 2018, 9, 5257-5261; L. Sonnenschein, A. Seubert. Tetrahedron Lett. 2011, 52, 1101-1104; E. M. Lewoczko, N. Wang, C. E. Lundberg, M. T. Kelly, E. W. Kent, T. Wu, M. Chen, J. Wang, B. Zhao. ACS Appl. Polym. Mater. 2021, 3, 2, 867-878. While the SB-substituted methacrylate polymers are widely used and prepared from commercially available monomers, reports on the styrenic version are much less frequent, with examples in the literature involving grafting-from chemistry on cellulose and segmented poly(ether urethane) (see, e.g., P. Liu, Q. Chen, X. Liu, B. Yuan, S. Wu, J. Shen, S. Lin. Biomacromolecules 2009, 10, 10, 2809-2816; J. Zhang, J. Yuan, Y. Yuan, X. Zang, J. Shen, S. Lin. Biomaterials 2003, 24, 23, 4223-4231), as well as components of copolymers that afford self-adhesive droplets (see, e.g., J. Zhao, Z. Pan, D. Snyder, H. A. Stone, T. Emrick. J. Am. Chem. Soc. 2021, 143, 14, 5558-5564).

The inverted SB structures prepared here benefit from greater variability in monomer composition associated with the facile nucleophilic ring-opening of sultone with any of a variety of amines. In contrast, the synthesis of conventionally substituted methacrylic sulfobetaines requires more complex synthetic routes involving secondary amines or asymmetric sulfonate-substituted tertiary amines. Such structural variation bears directly on properties. For example, conventionally oriented styrenic sulfobetaine polymers only dissolve in aqueous salt solution (i.e., not in pure water), whereas the novel ammonium sulfonate substituted polymers, except for the tri-n-octyl derivative, dissolve in pure water, and all dissolve in methanol.

### RAFT Polymerization of Zwitterion Ammonium Sulfonate and Sulfonium Sulfonate Monomers

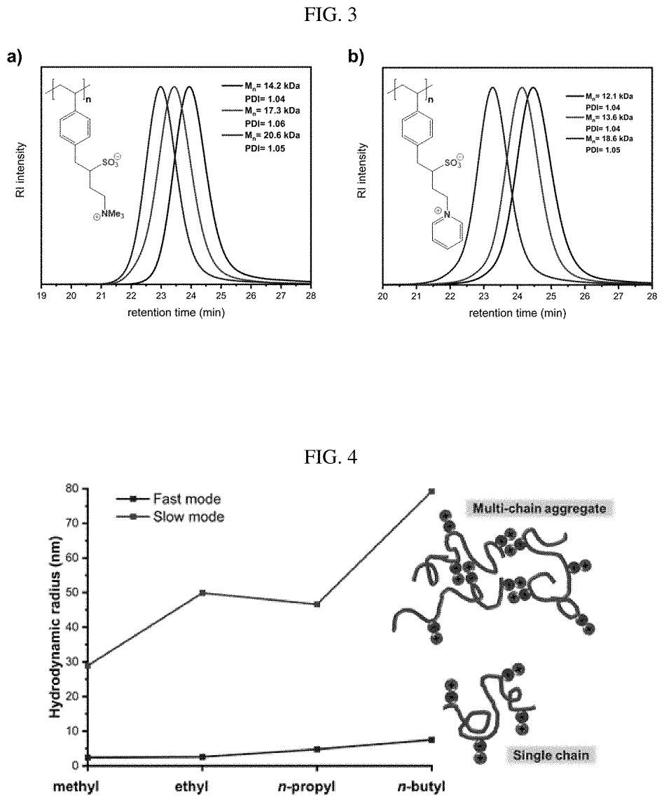

Controlled free radical polymerization was performed successfully on the zwitterionic monomers using reversible addition fragmentation chain-transfer polymerization (RAFT) in methanol at monomer concentrations ranging from 0.8-1.3 M. 4-Cyano-4-(dodecylsulfanylthiocarbonyl)sulfanyl] pentanoic acid was used as the chain transfer agent (CTA) and 4,4′-azobis(4-cyanopentanoic acid) (ACVA) as the initiator (in a 3:1 CTA:ACVA ratio). The polymerizations were conducted at 70° C. over a period of 18 h, targeting degree of polymerization (DP) values of 20, 30, and 50 for each derivative by variation of the monomer-to-CTA ratio. Typical monomer conversions were >80%, as calculated by integrating the characteristic aromatic and vinyl proton signals in the ¹H NMR spectra of the crude products. All of the polymers were purified by dialysis against water, or methanol followed by water, depending on their solubility and were characterized by ¹H NMR spectroscopy and gel permeation chromatography (GPC) using trifluoroethanol (TFE) as the eluent. Typical yields of the isolated polymers after dialysis ranged from 70% to 85%. ¹H NMR spectroscopy of the polymer products showed characteristic signal broadening and an absence of vinyl proton signals, indicating successful polymer formation and removal of residual monomer. Molecular weight characterization by GPC confirmed the success of RAFT for producing narrow molecular weight distributions, with dispersity (Ð) values <1.2 for all derivatives. Generally, molecular weights in the ≈10-30 kDa range were obtained, which correlated reasonably well with the targeted values. This is reflected in representative narrow, monomodal GPC traces shown in FIG. 3 for the trimethyl ammonium and pyridinium derivatives. Polymer solubility varied with selection of R-groups on the ammonium cations: all of the polymers proved soluble in methanol, while all but the tri-n-octyl derivative were soluble in water. Most derivatives were poorly soluble in chloroform, with exception of the tri-n-octyl pSAS. The low solubility of the tri-n-butyl pSAS in chloroform compared to the tri-n-butyl-substituted pSPS shows the impact of small structural changes and the increase in hydrophobicity when transitioning from ammonium to phosphonium PZs.

### PZ Characterization by Dynamic Light Scattering

Dynamic light scattering (DLS) was performed on the water-soluble PZs (Mn 13.6-17.9 kDa by GPC, target DP 30) and the phosphonium sulfonate (PS)-substituted polymer (where R=n-butyl, Mn 19.9 kDa by GPC, target DP 40). The measurements were conducted using aqueous polymer solutions at a concentration of 0.05 wt % on an ALV instrument (Angewandte Laser Vertriebsgesellschaft mbH, Hessen, Germany) at a scattering angle of 900 and the data obtained are summarized in Table 1 and FIG. 4.

TABLE 1

| Polymer | R= | Fast mode (nm) | Slow mode (nm) |
|---|---|---|---|
| SAS^{a)} | methyl | 2.4 | 28.9 |
| | ethyl | 2.6 | 49.9 |
| | propyl | 4.8 | 46.6 |
| | n-butyl | 7.5 | 79.2 |
| | pyridinium | 2.9 | 38.6 |
| SPS^{b)} | n-butyl | 3.3 | 51.1 |

^{a)}Target DP = 30;
^{b)}Target DP = 40

Two distinct relaxation or dynamical modes, which are referred to herein as the “fast mode” and the “slow mode” were used to describe the diffusive behavior of the PZs. These are extracted from the measured time autocorrelation functions, yielding distinct hydrodynamic radii at different length scales. Analogous to earlier dynamic light scattering study on PZs (see, e.g., C. F. Santa Chalarca, T. Emrick. J. Polym. Sci., Part A: Polym. Chem. 2017, 55, 83-92), the fast mode describes the dynamics of single polymer chains, whereas the slow mode corresponds to multi-chain aggregates of a larger length scale that can be attributed to inter-zwitterion interactions. Generally, the observation of multiple modes is consistent with previous light scattering studies of PZs. Similarly, for the PS-substituted PZs, fast and slow modes were observed. When comparing the hydrodynamic radii of the fast mode for the five water-soluble SAS PZs, a clear trend based on the R-substituents on the cationic moieties was observed. The hydrodynamic radii increased from 2.4 nm for the trimethyl SAS polymer to 7.5 nm for the tri-n-butyl SAS polymer, while the hydrodynamic radius of the pyridinium derivative (2.9 nm) was intermediate between that of the ethyl (2.6 nm) and n-propyl (4.8 nm) SAS polymers. Evidently, the single chain hydrodynamic radius depends on the R-substituent size, with longer alkyl chains resulting in larger solution structures. Light scattering evaluation of the four ammonium sulfonate PZs also revealed a general correlation between the alkyl chain length and the observed length scale of the slow mode. With larger R-groups, the hydrodynamic radii likewise increased, from 28.9 nm for the methyl derivative to 79.2 nm for the n-butyl derivative (see Table 1 and FIG. 4). Without wishing to be bound by theory, this behavior likely results from inter-chain packing within multi-chain assemblies, wherein the larger R-groups increase the length scale of such interactions. Moreover, specifically comparing the two tri-n-butyl substituted polymers, pSAS (ammonium) and pSPS (phosphonium), the fast and slow modes of pSAS (7.5 and 79.2 nm, respectively) were found to be significantly larger than those of the SPS polymer (3.3 and 51.1 nm, respectively), despite the greater DP of the latter. Thus, the solution aggregation of multiple chains is sensitive to both the chemistry of the alkyl substituents and the identity of the cationic center. Without wishing to be bound by theory, it is speculated that the ammonium cations may interact more favorably with water than the phosphonium cations, attributed to their smaller size and lower polarizability, which in turn allows the pSAS chains to adopt a larger, more solvent-swollen, configuration.

### Properties of Ammonium Sulfonate PZs at Fluid Interfaces

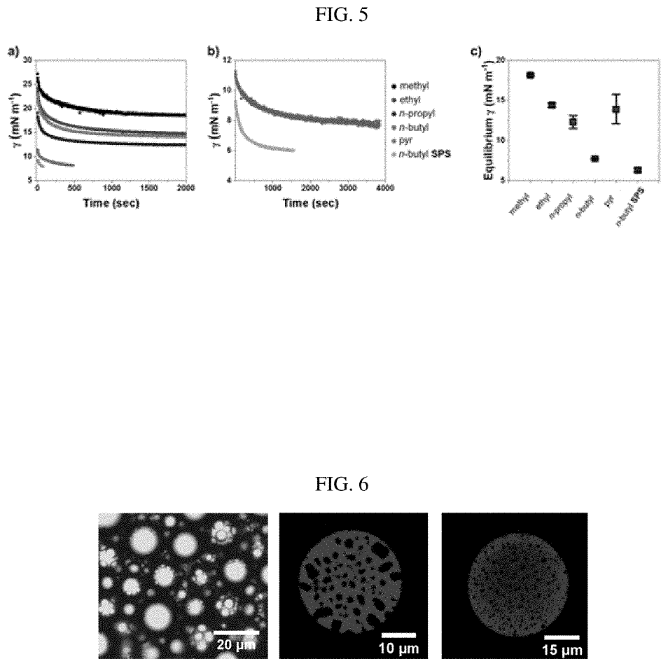

The fluid-fluid interfacial activity of the novel water-soluble SAS PZs was examined by pendant drop tensiometry (Data Physics OCA-15 plus tensiometer in pendant drop mode) using droplets of 1,2,4-trichlorobenzene (TCB) in aqueous polymer solutions. These experiments were conducted to assess the effect of the cationic substituents on the fluid-fluid interfacial tension (IFT). For this, SAS polymers synthesized with a target DP of 30, were used as 0.5 mg mL⁻¹ solutions in water. TCB was dispensed into the solutions with a flat tip needle (outer diameter=1.57 mm) to afford droplets of about 6 μL in volume. In FIG. 5(a), the evolution of the IFT as a function of time shows that both the initial and final values correlate inversely with alkyl group length, with longer alkyl chains affording lower IFT values. IFT changes proved substantial for this PZ series, declining by over 10 mN m⁻¹ when going from the methyl derivative (18.1 mN m-1) to the n-butyl-substituted (7.7 mN m-1), while the pyridinium substituted PZs, measuring 13.9 mN m⁻¹, resembled the ethyl and propyl derivatives. Evidently, larger hydrophobic substituents balance the hydrophilicity provided by the zwitterionic moieties, thus enhancing PZ amphiphilicity. As shown in FIG. 5(b), the ammonium versus phosphonium structures were again compared, using a needle of smaller outer diameter (0.82 mm, 21 G), as smaller droplet sizes (about 2 μL) were required to achieve stability in reaching the equilibrium IFT. As seen in FIG. 5(a), in the case of the tri-n-butyl ammonium and phosphonium derivatives, with the larger needles, the pendant droplets fell off the needle in less than 500 s, ending the measurement. Even with the smaller needle diameter (FIG. 5(b)) the droplet stabilized by the phosphonium-based polymer fell off at about 1500 s, sooner than in the measurement with the methyl ammonium-based polymer, attributed to the substantial reduction in IFT.

Nonetheless, judging from the asymptotic trajectory of the obtained data, we suggest that a quasi-equilibrium IFT was reached in these experiments. Tracking the IFT over time shows that the initial and final values for the phosphonium derivative (6.3 mN m⁻¹) are lower than those of the ammonium derivative (7.7 mN m⁻¹), indicating higher interfacial activity for the SPS polymer. Additionally, the initial decrease in IFT over time appears to proceed more rapidly for pSPS than pSAS, suggesting faster fluid-fluid interface assembly kinetics of the former. Overall, these experiments help build a library of charge-neutral PZ surfactants for which the choice of cation atom and its substituents finely tune interfacial properties in fluids, while providing fundamental insight into PZ structure-property relationships and their design criteria. Specifically, the interplay of the zwitterionic dipole and chemical makeup of the ion in large part determines polymer properties, with longer alkyl chains at the cationic center providing hydrophobicity that serves to increase interfacial activity for this polymer architecture. Additionally, the stronger polarizability of phosphonium compared to ammonium cations likely reduces hydrophilicity due to weaker association with surrounding water molecules which serves to increase the interfacial activity of the polymer.

### Use of Ammonium Sulfonate PZs in Complex Emulsion Formation

The surfactant properties of these new SAS PZs were investigated in droplet stabilization experiments through the preparation of oil-in-water emulsion droplets. For example, a mixture of TCB as the organic solvent and aqueous polymer solutions (10 mg mL⁻¹; 1 mL of each solvent phase) was mixed by vortexing in a scintillation vial for one minute. While the n-propyl and n-butyl-substituted PZs rapidly formed stable emulsions, the methyl derivative required multiple mixing cycles to form an emulsion phase that coalesced over a period of hours to days. These findings map well onto the pendant drop tensiometry results showing greater IFT reduction for PZs containing larger substituents on the ammonium cations, and further corroborate the concept of PZ interfacial tunability. Droplets prepared with the n-butyl derivative, which by pendant drop tensiometry showed the lowest IFT, were additionally characterized by confocal fluorescence microscopy using TCB solutions of Nile red to aid visualization. As shown in FIG. 6, water-in-oil-in-water (w/o/w) emulsions appear to form from this process, with smaller water droplets (dark regions, no dye) embedded within the larger, fluorescent TCB droplets suspended in a continuous aqueous medium.

Imaging of the emulsion phase by optical microscopy (FIG. 6, left) revealed the presence of smaller water droplets within larger oil droplets. Evidently, the amphiphilic nature and high interfacial activity of these PZs facilitates the formation of complex emulsions by simple vortex mixing, as opposed to multistep and/or microfluidic techniques. In addition to using a single polymeric surfactant to stabilize these types of droplets, the present system employs homopolymers, rather than block or other architectural variations, thus offering a simplified synthetic approach. The oil droplets containing smaller water droplets ranged primarily from 10 to 50 μm in diameter, while smaller droplets were also observed. Moreover, emulsions prepared in a similar manner with the tri-n-butyl phosphonium sulfonate polymer also facilitated w/o/w droplet formation, as seen by confocal fluorescence microscopy imaging. In accord with the IFT data, the seemingly greater interfacial activity of the SPS PZs is reflected by the smaller interior water droplets (1 μm) relative to those in the ammonium-based SAS system (2 μm); moreover, even upon prolonged storage (weeks to months), microscopy evaluation revealed the complex emulsions to persist.

In summary, the present inventors have described herein the facile synthesis of several novel zwitterionic ammonium sulfonate monomers by nucleophilic ring-opening of a versatile sultone precursor and examined their polymerization chemistry by controlled free radical methods. The polymers obtained showed uniquely tunable solution structure and interfacial properties for polymer zwitterions, and with distinct characteristics relative to their phosphonium-based counterparts, revealing the impact of the substituents on the cationic moiety and of the cationic center itself on PZ properties. The present studies showed that single polymer chain solution structures of the various pSAS derivatives, as well as the multi-chain aggregates, grow in hydrodynamic radius as the size of the cationic substituents increases. Moreover, their ability to reduce fluid-fluid interfacial tension increases with the size and hydrophobicity of the cation substituents, with the phosphonium sulfonate polymers displaying greater interfacial activity than their ammonium counterparts, likely due to greater polarizability of the phosphonium cations that weakens their interactions with surrounding water molecules.

Experimental details follow.

Experimental procedures, materials, and spectroscopic analysis. Air and moisture sensitive reactions were conducted under nitrogen (gas) atmosphere using conventional Schlenk techniques. Estimation of polymer molecular weights and polydispersity indices (Mn, Mw and PDI) was performed using gel permeation chromatography (GPC) against PMMA calibration standards, on an Agilent 1200 series system equipped with a degasser, refractive index detector, PFG guard column (8×50 mm) and PFG analytical linear M columns (8×300 mm, particle size 7 mm) from Polymer Standards Service, and an isocratic pump. The eluent was 2,2,2-trifluoroethanol (TFE) containing 0.02 M sodium trifluoroacetate and the system was operated at a flow rate of 1 m/min and at 40° C. ¹H and ¹³C NMR solution spectra were obtained on a Bruker 500 MHz Spectrometer and referenced to the residual solvent signals where available. Mass spectra were obtained with a Bruker microTOFII mass spectrometer. Interfacial tension values were obtained by pendant drop tensiometry, which was conducted with a Data Physics OCA-15plus tensiometer in pendant drop mode.

Materials. Tri-n-propylamine (98%), tri-n-butylamine, pyridine (anhydrous, 99.8%), 4′-azobis(4-cyanovaleric acid) (98%, ACVA), 4-vinylbenzyl chloride (90%, 500 ppm added tbutylcatechol), 1,2,4-trichlorobenzene (anhydrous, >99%) (TCB), n-BuLi (2.5 M in hexanes), and 1,3-propane sultone (98%) were purchased from Sigma Aldrich. Tri-n-octylamine (98%), sodium iodide (99+%), 2,2,2-trifluoroethanol (TFE, 99+%), and butylated hydroxytoluene (BHT, 99%) were obtained from Alfa Aesar. 4-Cyano-4-(((dodecylthio)carbonothioyl)thio)pentanoic acid was purchased from Boron Molecular. Triethylamine, water (HPLC grade), acetone, diethyl ether (anhydrous), sodium sulfate, ethyl acetate, tetrahydrofuran, toluene, chloroform, methanol, hexanes, and Spectra/Por7 dialysis membranes (3.5 kDa MWCO, pretreated regenerated cellulose tubing) were purchased from Fisher Scientific. Deuterated solvents for solution NMR analysis were acquired from Cambridge Isotope Laboratories, Inc (chloroform and methanol) and Acros Organics (water). Trimethylamine (pure, 4.2M (33 wt. %) solution in ethanol) was also purchased from Acros Organics and silica gel-coated TLC plates (glass backed, thickness: 250 um, UV254 active) were purchased from Sorbtech. Tetrahydrofuran and toluene were dried over Na(s) and freshly distilled before use. Reaction mixtures in methanol were degassed using three freeze-pump-thaw cycles prior to radical polymerization. Milli Q® ultrapure water (18.2 MΩcm) was used for interfacial tension measurements with blunt tip needles (outer diameter=0.82 mm) purchased from Brostown Technology.

### Monomer Synthesis

4-Vinylbenzyl iodide. Sodium iodide (49.1 g, 327 mmol) was dissolved in 175 mL of acetone, after which 4-vinylbenzyl chloride (10.0 g, 65.5 mmol) was added under nitrogen (gas) atmosphere. The reaction vessel was shielded from light and the mixture was stirred at room temperature for 48 h. The suspension was diluted with 70 mL of diethyl ether, then washed twice with 200 mL of deionized water and once with 200 mL of brine. The organic phase was dried over Na₂SO₄(s), and a clear orange oil was obtained after removal of solvents under reduced pressure (90% yield). ¹H-NMR (500 MHz, CDCl₃, δ): 7.34 ppm (s, 4H), 6.69 ppm (dd, J=17.5, 11.0 Hz, 1H), 5.76 ppm (d, J=17.5 Hz, 1H), 5.27 ppm (d, J=11.0 Hz, 1H), 4.47 ppm (s, 2H)¹³C-NMR (500 MHz, CDCl₃, δ): 138.9 ppm, 137.4 ppm, 136.4 ppm, 129.1 ppm, 126.8 ppm, 114.5 ppm, 5.9 ppm.

4-Vinylbenzyl sultone. A stirring solution of 1,3-propane sultone (2.75 g, 22.5 mmol) in dry THF (200 mL) was cooled by immersing the reaction flask into a dry ice/acetone bath. After slow addition of n-BuLi (2.5M in hexanes, 9.9 mL, 24.8 mmol), the reaction mixture was stirred at −78° C. for 1 h. 4-Vinylbenzyl iodide (5.5 g, 22.5 mmol) was added and the solution was stirred at −78° C. (excluding light) for 5.5 h, then quenched with 110 mL of deionized water. The crude product was extracted with toluene (3×180 mL), dried over Na₂SO₄, and purified by column chromatography on silica gel eluting with hexanes/ethyl acetate mixtures (gradient from 6:1 to 3:1 by volume) to afford the product as white solid (72% yield). ¹H-NMR (500 MHz, CDCl₃, δ): 7.38 ppm (d, J=8.5 Hz, 2H), 7.19 ppm (d, J=8.0 Hz, 2H), 6.69 ppm (dd, J=17.5, 11.0 Hz, 1H), 5.74 ppm (d, J=17.0 Hz, 1H), 5.26 ppm (d, J=11.0 Hz, 1H), 4.43 ppm (td, J=9.0, 3.5 Hz, 1H), 4.33 ppm (td, J=8.5, 7.5 Hz, 1H), 3.50 ppm (m, 1H), 3.38 ppm (dd, J=14.0, 5.5 Hz, 1H), 2.87 ppm (dd, J=14.0, 10.0 Hz, 1H), 2.49 ppm (m, 1H), 2.35 ppm (m, 1H), ¹³C-NMR (500 MHz, CDCl3, δ): 137.0 ppm, 136.3 ppm, 135.6 ppm, 129.1 ppm, 126.9 ppm, 114.4 ppm, 67.0 ppm, 56.6 ppm, 34.4 ppm, 29.3 ppm, ESI (m/z): 261.06 (C₁₂H₁₄O₃SNa, calculated: 261.06).

4-(Trimethylammonio)-1-(4-vinylphenyl)butane-2-sulfonate. 4-Vinylbenzyl sultone (1.0 g, 4.2 mmol) and BHT (185 mg, 0.8 mmol) were dissolved in dry toluene (10 mL) under nitrogen (gas) atmosphere. Trimethylamine (4.2M in ethanol, 5.0 mL, 21.0 mmol) was added and the solution was stirred at 80° C. for 20 hours. The crude precipitate was washed three times each with 30 mL of toluene followed by diethyl ether. The product was isolated as colorless solid upon drying under reduced pressure (99% yield). ¹H-NMR (500 MHz, MeOD, δ): 7.43 ppm (d, J=8.0 Hz, 2H), 7.30 ppm (d, J=8.5 Hz, 2H), 6.73 ppm (dd, J=17.5, 11.0 Hz, 1H), 5.77 ppm (d, J=17.5 Hz, 1H), 5.22 ppm (d, J=11.0 Hz, 1H), 3.71 ppm (m, 1H), 3.50 ppm (m, 1H), 3.32 ppm (m, 1H), 3.03 ppm (m, 1H), 3.02 ppm (s, 9H), 2.72 ppm (m, 1H), 2.07 ppm (m, 2H), ¹³C-NMR (500 MHz, MeOD, δ): 139.5 ppm, 137.73 ppm, 137.66 ppm, 130.5 ppm, 127.7 ppm, 113.9 ppm, 65.8 ppm, 60.1 ppm, 53.3 ppm, 37.0 ppm, 23.8 ppm, ESI (m/z): 320.13 (C₁₅H₂₃NO₃SNa, calculated: 320.13).

4-(Triethylammonio)-1-(4-vinylphenyl)butane-2-sulfonate. The synthesis was performed according to the procedure outlined above, heating at 90° C. and using triethylamine as the nucleophile (96% yield). ¹H-NMR (500 MHz, MeOD, δ): 7.45 ppm (d, J=8.0 Hz, 2H), 7.31 ppm (d, J=8.0 Hz, 2H), 6.74 ppm (dd, J=18.0, 11.0 Hz, 1H), 5.78 ppm (d, J=18.0 Hz, 1H), 5.23 ppm (d, J=11.0 Hz, 1H), 3.57 ppm (m, 1H), 3.51 ppm (m, 1H), 3.19 ppm (m, 6H), 3.06 ppm (m, 1H), 3.00 ppm (m, 1H), 2.71 ppm (m, 1H), 2.05 ppm (m, 1H), 1.87 ppm (m, 1H), 1.14 ppm (t, 9H)¹³C-NMR (500 MHz, MeOD, δ): 139.5 ppm, 137.74 ppm, 137.68 ppm, 130.6 ppm, 127.7 ppm, 114.0 ppm, 60.0 ppm, 56.3 ppm, 53.6 ppm, 37.2 ppm, 22.2 ppm, 7.4 ppm ESI (m/z): 362.18 (C₁₈H₂₉NO₃SNa, calculated: 362.18).

4-(Tripropylammonio)-1-(4-vinylphenyl)butane-2-sulfonate. The synthesis was conducted according to the procedure outlined, heating at 90° C. and using tripropylamine as the nucleophile (94% yield). ¹H-NMR (500 MHz, MeOD, δ): 7.45 ppm (d, J=8.0 Hz, 2H), 7.30 ppm (d, J=8.0 Hz, 2H), 6.74 ppm (dd, J=17.5, 11.0 Hz, 1H), 5.78 ppm (d, J=17.5 Hz, 1H), 5.24 ppm (d, J=11.0 Hz, 1H), 3.61 ppm (m, 1H), 3.50 ppm (m, 1H), 3.01 ppm (m, 8H), 2.69 ppm (m, 1H), 2.02 ppm (m, 1H), 1.80 ppm (m, 1H), 1.59 ppm (m, 3H), 1.42 ppm (m, 3H), 0.88 ppm (t, 9H)¹³C-NMR (500 MHz, MeOD, δ): 139.5 ppm, 137.74 ppm, 137.70 ppm, 130.6 ppm, 127.7 ppm, 114.0 ppm, 60.0 ppm, 59.2 ppm, 57.9 ppm, 37.2 ppm, 24.5 ppm, 22.2 ppm, 20.6 ppm, 13.9 ppm ESI (m/z): 404.22 (C₂₁H₃₅NO₃SNa, calculated: 404.22).

4-(Tributylammonio)-1-(4-vinylphenyl)butane-2-sulfonate. The synthesis was carried out according to the procedure outlined above, using tributylamine as the nucleophile (87% yield). ¹H-NMR (500 MHz, MeOD, δ): 7.44 ppm (d, J=8.0 Hz, 2H), 7.30 ppm (d, J=8.0 Hz, 2H), 6.73 ppm (dd, J=17.5, 11.0 Hz, 1H), 5.78 ppm (d, J=17.8 Hz, 1H), 5.23 ppm (d, J=11.0 Hz, 1H), 3.65 ppm (m, 1H), 3.50 ppm (m, 1H), 3.09 ppm (m, 7H), 2.97 ppm (m, 1H), 2.68 ppm (m, 1H), 2.01 ppm (m, 1H), 1.82 ppm (m, 1H), 1.55 ppm (m, 3H), 1.40 ppm (m, 3H), 1.28 ppm (m, 6H), 0.93 ppm (t, 9H)¹³C-NMR (500 MHz, MeOD, δ): 139.4 ppm, 137.76 ppm, 137.69 ppm, 130.6 ppm, 127.7 ppm, 114.0 ppm, 60.9 ppm, 60.0 ppm, 58.1 ppm, 37.2 ppm, 22.1 ppm, 16.0 ppm, 10.8 ppm ESI (m/z): 446.27 (C₂₄H₄₁NO₃SNa, calculated: 446.27).

4-(Trioctylammonio)-1-(4-vinylphenyl)butane-2-sulfonate. The synthesis was carried out according to the procedure outlined above, heating at 95° C. for 96 hours using tributylamine as the nucleophile and including an additional washing step with THF prior to washing with diethyl ether (90% yield). ¹H-NMR (500 MHz, MeOD, δ): 7.43 ppm (d, J=8.0 Hz, 2H), 7.30 ppm (d, J=8.0 Hz, 2H), 6.72 ppm (dd, J=17.5, 11.0 Hz, 1H), 5.78 ppm (d, J=17.5 Hz, 1H), 5.23 ppm (d, J=11.0 Hz, 1H), 3.63 ppm (m, 1H), 3.49 ppm (m, 1H), 3.08 ppm (m, 7H), 2.98 ppm (m, 1H), 2.68 ppm (m, 1H), 2.00 ppm (m, 1H), 1.82 ppm (m, 1H), 1.55 ppm (m, 3H), 1.42 ppm (m, 3H), 1.28 ppm (m, 30H), 0.92 ppm (t, 9H)¹³C-NMR (500 MHz, MeOD, a): 139.5 ppm, 137.7 ppm, 137.6 ppm, 130.6 ppm, 127.7 ppm, 114.0 ppm, 59.9 ppm, 59.4 ppm, 57.8 ppm, 37.1 ppm, 32.9 ppm, 30.3 ppm, 30.1 ppm, 27.3 ppm, 23.7 ppm, 22.5 ppm, 22.2 ppm, 14.4 ppm ESI (m/z): 614.46 (C₃₆H₆₅NO₃SNa, calculated: 614.46).

4-(1-Pyridinio)-1-(4-vinylphenyl)butane-2-sulfonate. The synthesis was conducted according to the procedure outlined above, heating at 100° C. using tributylamine as the nucleophile (98% yield). ¹H-NMR (500 MHz, MeOD, δ): 8.79 ppm (d, J=6.0 Hz, 2H), 8.52 ppm (t, J=7.5 Hz, 1H), 7.98 ppm (t, J=7.0 Hz, 2H), 7.33 ppm (d, J=8.0 Hz, 2H), 7.11 ppm (d, J=8.0 Hz, 2H), 6.72 ppm (dd, J=17.5, 11.0 Hz, 1H), 5.77 ppm (d, 18.0 Hz, 1H), 5.23 ppm (d, 11.0 Hz, 1H), 4.80 ppm (m, 2H), 3.46 ppm (m, 1H), 2.84 ppm (m, 1H), 2.63 ppm (m, 1H), 2.41 ppm (m, 1H), 2.19 ppm (m, 1H), ¹³C-NMR (500 MHz, MeOD, 6): 146.8 ppm, 145.9 ppm, 139.4 ppm, 137.7 ppm, 137.5 ppm, 130.4 ppm, 129.4 ppm, 127.7 ppm, 114.0 ppm, 61.3 ppm, 59.3 ppm, 37.5 ppm, 32.1 ppm, ESI (m/z): 340.10 (C₁₇H₁₉NO₃SNa, calculated: 340.10).

Methyl SAS Polymer. The trimethylammonium sulfonate monomer was polymerized via RAFT, with target degrees of polymerization (DP) of 20, 30 and 50. For this, 150 mg of monomer (0.50 mmol: 20, 30 or 50 equ.) were dissolved in methanol at a monomer concentration of 1.1 M together with 1 equivalent of CTA and 0.33 equivalents of ACVA. The solution was degassed via freeze-pump-thaw and blanketed with N₂(g) before heating (heating block temperature=70° C.) for 18 h. The reaction was quenched by immersing the vial in liquid N₂ while opening it to air, then the crude was purified by dialysis against water (typical yield: >85%).

Ethyl SAS Polymer. These polymers were prepared according to the procedure mentioned above with a monomer concentration of 1.3M (typical yield: >70%).

N-Propyl SAS Polymer. These polymers were prepared according to the procedure outlined above with a monomer concentration of 1.3M (typical yield: >70%).

N-Butyl SAS Polymer. These polymers were prepared according to the procedure detailed above (typical isolated yield: >70%).

N-Octyl SAS Polymer. These polymers were prepared according to the procedure mentioned above with a monomer concentration of 0.8M.

Pyridinium SAS Polymer. These polymers were prepared according to the procedure outlined above (typical yield: >70%).

4-(butyl methyl sulfonio)-1-(4-vinylphenyl)butane-2-sulfonate. 4-Vinylbenzyl sultone and BHT were dissolved in dry acetonitrile under nitrogen (gas) atmosphere. Butyl methyl sulfide was added and the solution was stirred at 75° C. The product was isolated in 40% yield.

Butyl Methyl SSS Polymer. These polymers were prepared according to the procedure mentioned above. GPC analysis indicated a number average molecular weight of 11,300 grams per mole and a dispersity of 1.03.

Pendant drop tensiometry. The interfacial tension measurements for TCB in aqueous polymer solutions at a concentration of 0.5 mgml⁻¹ were conducted using a Data Physics OCA-15 plus tensiometer in pendant drop mode by dispensing a hanging drop of the oil into the polymer solutions from a blunt tip needle of two different outer diameters (0.82 and 1.57 mm respectively). The droplet sizes were adjusted to 6-7 μL for the larger and 2-3 μL for the smaller needle. Images of the droplet were recorded in 1 second intervals and the IFT values were calculated from the droplet shape according to conventional methods.

Confocal fluorescence microscopy. Confocal fluorescence microscopy was carried out on a Nikon AiR confocal microscope with a 20×objective. A far-red laser with an excitation wavelength of 640 nm and 700/75 nm emission filter wavelength, was used to obtain single slice images and the Z-stack projections. The emulsions were deposited on a microscopy glass slide, and covered with a glass cover slide. The step size for the Z-stack experiments was set to 1 μm.

Dynamic light scattering. DLS measurements were conducted using aqueous polymer solutions at a concentration of 0.05 wt % on an ALV instrument (Angewandte Laser Vertriebsgesellschaft mbH, Hessen, Germany) at a scattering angle of 90 degrees. The data were analyzed using HDRC data fitting software (6.0.1). Decay times were obtained from the measured time autocorrelation functions collected with an ALV/LSE-5004 Multiple Tau Digital Correlator and fit to multiple exponential decay functions. Each of the relaxation times is converted to a corresponding diffusion coefficient, then a hydrodynamic radius using the Stokes-Einstein relationship. The data demonstrate the presence of multiple relaxation modes—in other words, two distinct diffusion coefficients/hydrodynamic radii can be extracted from each of the autocorrelation functions obtained via DLS.

This disclosure further encompasses the following aspects.

Aspect 1: A zwitterion of the Formula

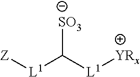

wherein Z is a polymerizable group comprising ethylenic unsaturation; L¹ is a single bond or divalent C₁₋₆ alkylene group; L² is a divalent ethylene or propylene group; Y is N or S; R is independently at each occurrence a substituted or unsubstituted C₁₋₁₈ alkyl group or a substituted or unsubstituted C₆₋₂₀ aryl group, and x is 2 or 3, provided that when Y is S, x is 2; and when Y is N and x is 2, the R groups are joined together to form a substituted or unsubstituted aromatic ring.

Aspect 2: The zwitterion of aspect 1, wherein Z is a group of the Formula

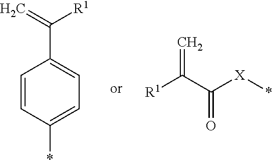

wherein R¹ is H or a methyl group, and X is —O— or —NH—.

Aspect 3: The zwitterion of aspect 1 or 2, wherein the zwitterion is of the Formula

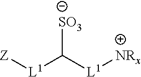

wherein Z is a polymerizable group comprising ethylenic unsaturation; L¹ is a single bond or divalent C₁₋₆ alkylene group; L² is a divalent ethylene or propylene group; R is independently at each occurrence a substituted or unsubstituted C₁₋₁₈ alkyl group, and x is 2 or 3, provided that when x is 2, the R groups are joined together to form a substituted or unsubstituted aromatic ring.

Aspect 4: The zwitterion of any of aspects 1 to 3, wherein the zwitterion is of the Formula

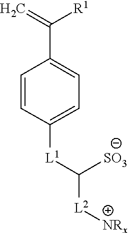

wherein R¹ is H or a methyl group, preferably H; L¹ is a divalent C₁₋₆ alkylene group, preferably a divalent methylene group; L² is a divalent ethylene or propylene group; R is independently at each occurrence a substituted or unsubstituted C₁₋₁₈ alkyl group, and x is 2 or 3, provided that when x is 2, the R groups are joined together to form a substituted or unsubstituted aromatic ring.

Aspect 5: The zwitterion of aspect 4, wherein L² is a divalent ethylene group, and the zwitterion is of the Formula

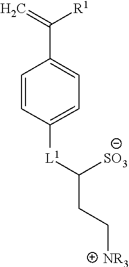

wherein R¹ is H or a methyl group; L¹ is a divalent C₁₋₆ alkylene group; and R is independently at each occurrence a substituted or unsubstituted C₁₋₁₈ alkyl group.

Aspect 6: The zwitterion of any of aspects 4 to 5, wherein R¹ is H, L¹ is a divalent methylene group, L² is a divalent ethylene group, x is 3, and each occurrence of R is methyl, preferably wherein the zwitterion is of the Formula

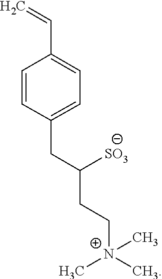

Aspect 7: The zwitterion of any of aspects 4 to 5, wherein R¹ is H, L¹ is a divalent methylene group, L² is a divalent ethylene group, x is 3, and each occurrence of R is ethyl, preferably wherein the zwitterion is of the Formula

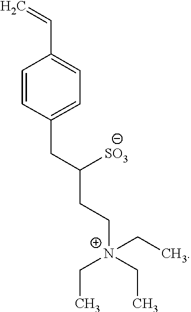

Aspect 8: The zwitterion of any of aspects 4 to 5, wherein R¹ is H, L¹ is a divalent methylene group, L² is a divalent ethylene group, x is 3, and each occurrence of R is n-propyl, preferably wherein the zwitterion is of the Formula

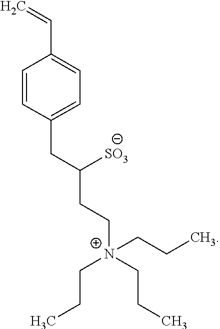

Aspect 9: The zwitterion of any of aspects 4 to 5, wherein R¹ is H, L¹ is a divalent methylene group, L² is a divalent ethylene group, x is 3, and each occurrence of R is n-butyl, preferably wherein the zwitterion is of the Formula

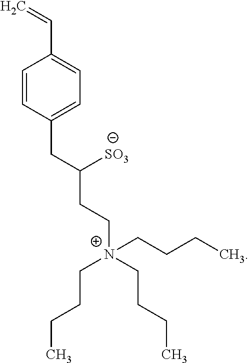

Aspect 10: The zwitterion of any of aspects 4 to 5, wherein R¹ is H, L¹ is a divalent methylene group, L² is a divalent ethylene group, x is 3, and each occurrence of R is n-octyl, preferably wherein the zwitterion is of the Formula

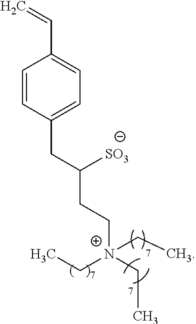

Aspect 11: The zwitterion of any of aspects 4 to 5, wherein R¹ is H, L¹ is a divalent methylene group, L² is a divalent ethylene group, x is 2 and the R groups are joined together to form an unsubstituted pyridinium ring, preferably wherein the zwitterion is of the Formula

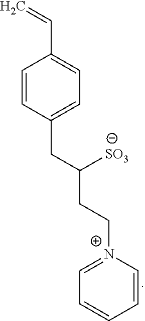

Aspect 12: The zwitterion of aspect 1 or 2, wherein the zwitterion is of the Formula

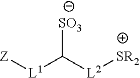

wherein Z is a polymerizable group comprising ethylenic unsaturation; L¹ is a single bond or divalent C₁₋₆ alkylene group; L² is a divalent ethylene or propylene group; and R is independently at each occurrence a substituted or unsubstituted C₁₋₁₈ alkyl group or a substituted or unsubstituted C₆₋₂₀ aryl group.

Aspect 13: The zwitterion of aspect 12, wherein the zwitterion is of the Formula

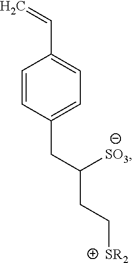

preferably wherein each occurrence of R is different.

Aspect 14: A polymer comprising repeating units derived from the zwitterion of any of aspects 1 to 13.

Aspect 15: The polymer of aspect 14, wherein the polymer comprises repeating units of the formula

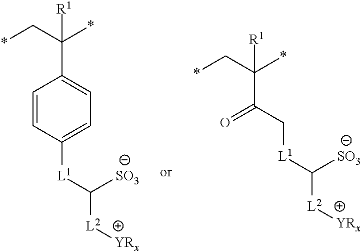

wherein R¹ is H or a methyl group; X is —O— or —NH—; L¹ is a single bond or a divalent C₁₋₆ alkylene group; L² is a divalent ethylene or propylene group; Y is N or S; R is independently at each occurrence a substituted or unsubstituted C₁₋₁₈ alkyl group or a substituted or unsubstituted C₆₋₂₀ aryl group; and x is 2 or 3, provided that when Y is S, x is 2; and when Y is N and x is 2, the R groups are joined together to form a substituted or unsubstituted aromatic ring.

Aspect 16: The polymer of aspect 15, wherein R¹ is H, L¹ is a methylene group, and L² is an ethylene group.

Aspect 17: The polymer of aspects 14 to 16, wherein the polymer comprises repeating units of the Formula

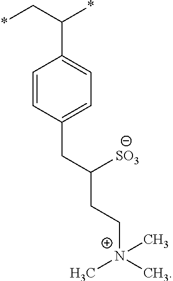

Aspect 18: The polymer of aspects 14 to 16, wherein the polymer comprises repeating units of the Formula

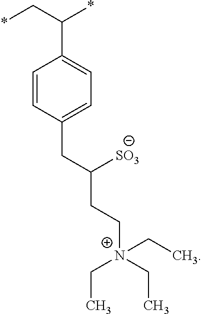

Aspect 19: The polymer of aspects 14 to 16, wherein the polymer comprises repeating units of the Formula

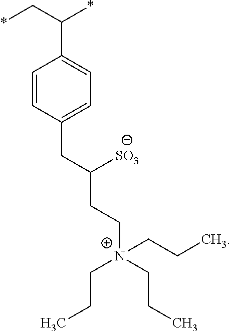

Aspect 20: The polymer of aspects 14 to 16, wherein the polymer comprises repeating units of the Formula

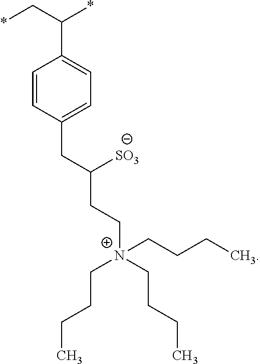

Aspect 21: The polymer of aspects 14 to 16, wherein the polymer comprises repeating units of the Formula

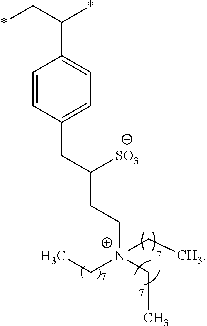

Aspect 22: The polymer of aspects 14 to 16, wherein the polymer comprises repeating units of the Formula

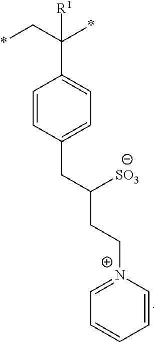

Aspect 23: The polymer of aspects 14 to 16, wherein the polymer comprises repeating units of the Formula

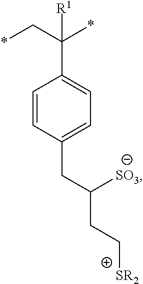

preferably wherein each occurrence of R is different.

Aspect 24: The polymer of any of aspects 14 to 23, wherein the polymer has a number average molecular weight of 1,000 to 100,000 grams per mole, preferably 5,000 to 50,000 grams per mole, more preferably 5,000 to 25,000 grams per mole, as determined using gel permeation chromatography in trifluoroethanol relative to poly(methyl methacrylate) standards.

Aspect 25: A method of making the polymer of any of aspects 14 to 24, the method comprising: contacting the zwitterion of any of aspects 1 to 13 and an initiator under conditions effective to provide the polymer; preferably, wherein the method comprises: contacting the ammonium sulfonate zwitterion, a free radical initiator, and a chain transfer agent in the present of a solvent under conditions effective to provide the polymer.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A zwitterion of the Formula 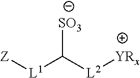
wherein
Z is a polymerizable group comprising ethylenic unsaturation;
L¹ is a single bond or divalent C₁₋₆ alkylene group;
L² is a divalent ethylene or propylene group;
Y is N or S;
R is independently at each occurrence a substituted or unsubstituted C₁₋₁₈ alkyl group or a substituted or unsubstituted C₆₋₂₀ aryl group, and
x is 2 or 3, provided that
when Y is S, x is 2; and
when Y is N and x is 2, the R groups are joined together to form a substituted or unsubstituted aromatic ring.

2. The zwitterion of claim 1, wherein Z is a group of the Formula 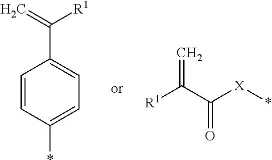
wherein R¹ is H or a methyl group, and X is —O— or —NH—.

3. The zwitterion of claim 1, wherein the zwitterion is of the Formula 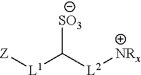
wherein
Z is a polymerizable group comprising ethylenic unsaturation;
L¹ is a single bond or divalent C₁₋₆ alkylene group;
L² is a divalent ethylene or propylene group;
R is independently at each occurrence a substituted or unsubstituted C₁₋₁₈ alkyl group, and
x is 2 or 3, provided that when x is 2, the R groups are joined together to form a substituted or unsubstituted aromatic ring.

4. The zwitterion of claim 1, wherein the zwitterion is of the Formula 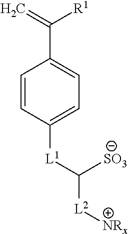
wherein
R¹ is H or a methyl group;
L¹ is a divalent C₁₋₆ alkylene group;
L² is a divalent ethylene or propylene group;
R is independently at each occurrence a substituted or unsubstituted C₁₋₁₈ alkyl group, and
x is 2 or 3, provided that when x is 2, the R groups are joined together to form a substituted or unsubstituted aromatic ring.

5. The zwitterion of claim 4, wherein L² is a divalent ethylene group, and the zwitterion is of the Formula 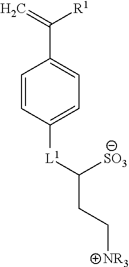
wherein
R¹ is H or a methyl group;
L¹ is a divalent C₁₋₆ alkylene group; and
R is independently at each occurrence a substituted or unsubstituted C₁₋₁₈ alkyl group.

6. The zwitterion of claim 4, wherein R¹ is H, L¹ is a divalent methylene group, L² is a divalent ethylene group, x is 3, and each occurrence of R is methyl, and the zwitterion is of the Formula

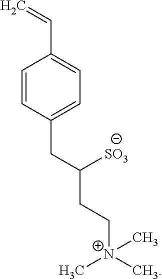

7. The zwitterion of claim 4, wherein R¹ is H, L¹ is a divalent methylene group, L² is a divalent ethylene group, x is 3, and each occurrence of R is ethyl, and the zwitterion is of the Formula

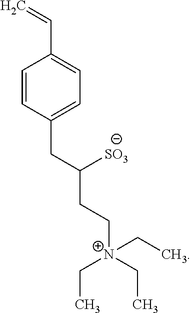

8. The zwitterion of claim 4, wherein R¹ is H, L¹ is a divalent methylene group, L² is a divalent ethylene group, x is 3, and each occurrence of R is n-propyl, and the zwitterion is of the Formula

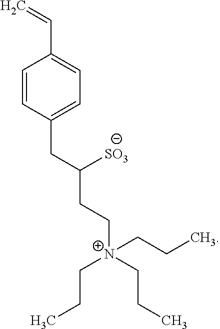

9. The zwitterion of claim 4, wherein R¹ is H, L¹ is a divalent methylene group, L² is a divalent ethylene group, x is 3, and each occurrence of R is n-butyl, and the zwitterion is of the Formula

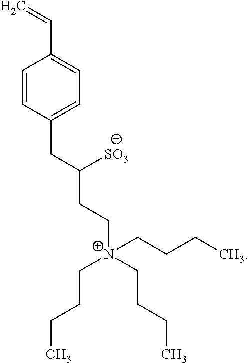

10. The zwitterion of claim 4, wherein R¹ is H, L¹ is a divalent methylene group, L² is a divalent ethylene group, x is 3, and each occurrence of R is n-octyl, and the zwitterion is of the Formula

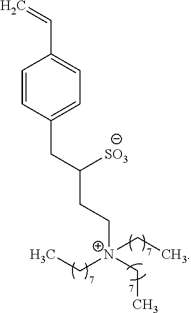

11. The zwitterion of claim 4, wherein R¹ is H, L¹ is a divalent methylene group, L² is a divalent ethylene group, x is 2 and the R groups are joined together to form an unsubstituted pyridinium ring, and the zwitterion is of the Formula

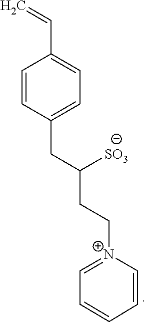

12. The zwitterion of claim 1, wherein the zwitterion is of the Formula 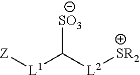
wherein
Z is a polymerizable group comprising ethylenic unsaturation;
L¹ is a single bond or divalent C₁₋₆ alkylene group;
L² is a divalent ethylene or propylene group; and
R is independently at each occurrence a substituted or unsubstituted C₁₋₁₈ alkyl group or a substituted or unsubstituted C₆₋₂₀ aryl group.

13. The zwitterion of claim 12, wherein the zwitterion is of the Formula 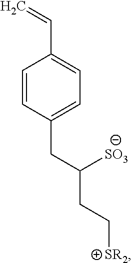
wherein each occurrence of R is the same or different.

14. A polymer comprising repeating units derived from the zwitterion of claim 1.

15. The polymer of claim 14, wherein the polymer comprises repeating units of the formula 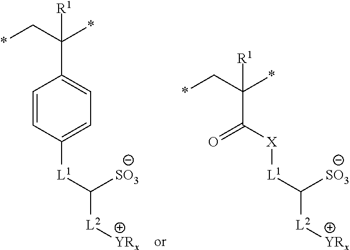
wherein
R¹ is H or a methyl group;
X is —O— or —NH—;
L¹ is a single bond or a divalent C₁₋₆ alkylene group;
L² is a divalent ethylene or propylene group;
Y is N or S;
R is independently at each occurrence a substituted or unsubstituted C₁₋₁₈ alkyl group or a substituted or unsubstituted C₆₋₂₀ aryl group; and
x is 2 or 3, provided that
when Y is S, x is 2; and
when Y is N and x is 2, the R groups are joined together to form a substituted or unsubstituted aromatic ring.

16. The polymer of claim 14, wherein the polymer comprises repeating units of the Formula

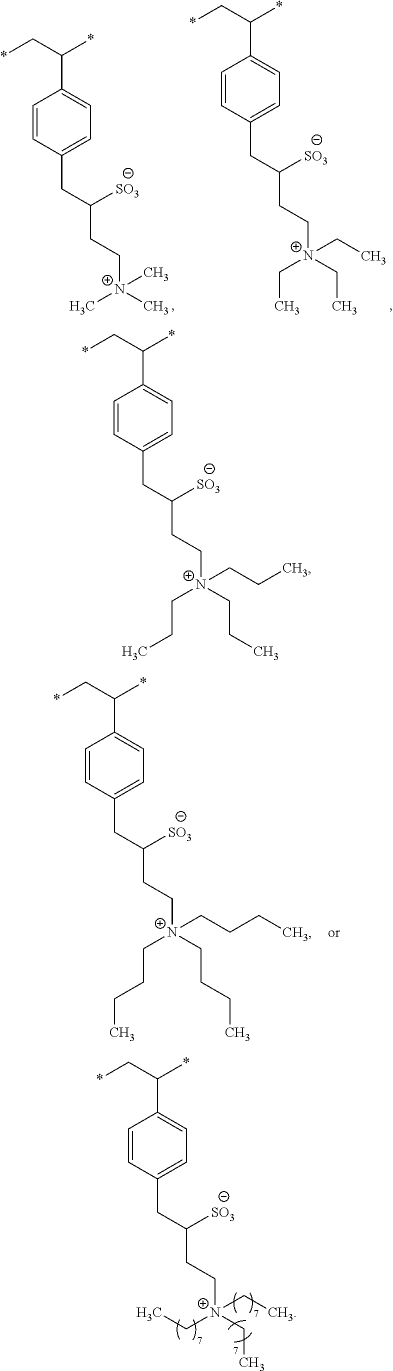

17. The polymer of claim 14, wherein the polymer comprises repeating units of the Formula 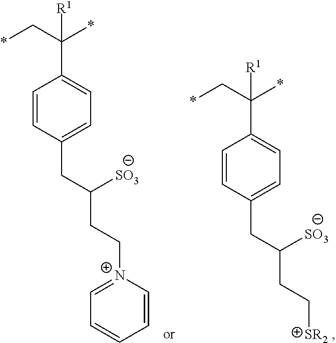
wherein each occurrence of R is the same or different.

18. The polymer of claim 14, wherein the polymer has a number average molecular weight of 1,000 to 100,000 grams per mole, as determined using gel permeation chromatography in trifluoroethanol relative to poly(methyl methacrylate) standards.

19. A method of making the polymer of claim 14, the method comprising:
contacting a zwitterion and an initiator under conditions effective to provide the polymer, wherein the zwitterion is of the Formula 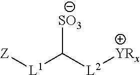
wherein
Z is a polymerizable group comprising ethylenic unsaturation;
L¹ is a single bond or divalent C₁₋₆ alkylene group;
L² is a divalent ethylene or propylene group;
Y is N or S;
R is independently at each occurrence a substituted or unsubstituted C₁₋₁₈ alkyl group or a substituted or unsubstituted C₆₋₂₀ aryl group, and
x is 2 or 3, provided that
when Y is S, x is 2; and
when Y is N and x is 2, the R groups are joined together to form a substituted or unsubstituted aromatic ring.
